(19) United States
(12) Patent Application Publication
(10) Pub. No.: US 2014/0091039 A1
(43) Pub. Date: Apr. 3, 2014

(54) SYSTEM AND METHOD FOR THE TREATMENT OF HYDRAULIC FRACTURING BACKFLOW WATER

(71) Applicant: GENERAL ELECTRIC COMPANY, Schenectady, NY (US)

(72) Inventor: Jonathon Karston Tait DUECK, Red Deer (CA)

(73) Assignee: General Electric Company, Schenectady, NY (US)

(21) Appl. No.: 13/630,959

(22) Filed: Sep. 28, 2012

(51) Int. Cl. C02F 9/06; C02F 1/20; C02F 1/42; C02F 1/469; C02F 1/66; C02F 5/02; C02F 1/44

(52) U.S. Cl. 210/638; 210/243; 210/195.2; 210/202; 210/188; 210/652; 210/639

(57) ABSTRACT

Hydraulic fracturing produces backflow water that is high in total dissolved solids, hardness and silica. A system to treat backflow water has an electrical separation unit and a reverse osmosis (RO) unit. The electrical separation unit may comprise an electrodialysis device (ED), an electrodialysis reversal (EDR) device or a supercapacitive desalination (SCD) device, or a combination thereof. The electrical separation unit may be combined with a precipitation unit and reduces the TDS and hardness of the backflow water. The RO unit reduces the silica concentration of the backflow water. A pre-treatment unit may further condition backflow water treated in the electrical separation unit to inhibit fouling in the RO unit. The treated backflow water may be suitable for reuse in hydraulic fracturing or discharge.

### FIELD

The present disclosure relates to the treatment of water associated with hydraulic fracturing in oil and gas production.

### BACKGROUND

Hydraulic fracturing is a treatment used to stimulate production of oil and gas from within a geological formation. The process involves injecting high pressure treatment fluids, also referred to as frac water, into a wellbore. The frac water exits the wellbore at specific locations to access stress points in the formation. The frac water cause fractures in the formation that improves communication between the reservoir and the wellbore.

When the fracturing process is completed, backflow water is recovered from the wellbore. Backflow water may contain frac water, produced water from the reservoir, and compounds that are washed from the formation. Typically, backflow water is brackish with a total dissolved solids (TDS) content that can be greater than 10,000 ppm.

Hydraulic fracturing requires vast quantities of frac water, which can place a high demand on limited water sources and produce large volumes of backflow water. The high TDS content, however, prevents reuse or disposal of the backflow water without treatment.

### INTRODUCTION

A system for treating backflow water is described in this specification. The system comprises an electrical separation unit and a reverse osmosis (RO) unit. Optionally, the electrical separation unit may be combined with a precipitation unit. Optionally, the RO unit may be associated with a conditioning unit such as a chemical dosing system containing an anti-scalant or a base, or a softener, or both.

A method for treating backflow water described in the specification comprises a step of TDS removal followed by a step of silica removal. The step of TDS removal may be performed in an electrical separation unit. The step of silica removal may be performed in an RO unit.

### BRIEF DESCRIPTION OF THE DRAWINGS

FIG. 1 is a schematic diagram of a water treatment system having an electrical separation unit and a reverse osmosis unit.

FIG. 2 is a schematic diagram of a second water treatment system having an electrical separation unit and a reverse osmosis unit similar to FIG. 1 and a precipitation unit.

FIG. 3 is a schematic diagram of a third water treatment system having an electrical separation unit, reverse osmosis unit and precipitation unit similar to FIG. 2 and a conditioning unit associated with the RO unit.

### DETAILED DESCRIPTION

Hydraulic fracturing backflow water typically has high concentrations of TDS, hardness and silica. A treatment system or method preferably reduces the concentrations of all three of these compounds such that the backflow water can be discharged or re-used.

The combination of hardness, TDS, and silica makes backflow water difficult to treat. In addition, hydraulic fracturing operations are typically set up only temporarily at remote sites. There is typically no significant source of heat at these sites. Accordingly, while hardness and silica can be reduced by hot or warm lime softening, there is typically no boiler blowdown stream, low-pressure exhaust steam or any other thermal waste stream available to make lime softening economically feasible. Water with very high TDS (i.e. greater than 50,000 ppm) can be efficiently treated with an evaporator. However, evaporators also require heat and may also be limited by the formation of scale if the water being treated has both high hardness and high silica concentrations. The backflow water has too much hardness and silica to be treated by reverse osmosis directly, even with the use of anti-scalants.

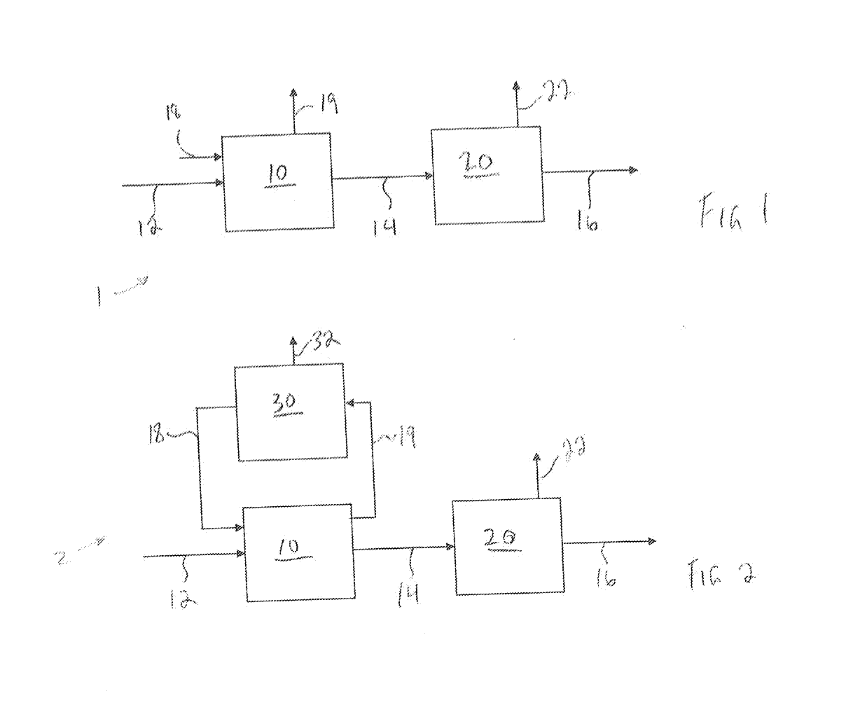

As depicted in FIG. 1, a system 1 comprises an electrical separation unit 10 and a reverse osmosis (RO) unit 20. The electrical separation unit 10 receives a first, or feed, stream 12 of backflow water or another source of water high in total dissolved solids (TDS), hardness and silica. For example, the first stream 12 may have a TDS concentration of 10,000 to 50,000 ppm, a hardness concentration of 500 to 5000 ppm and a silica concentration of 100 to 300 ppm. The electrical separation unit 10 may also receive a fourth stream 18 that has some TDS concentration as well.

The electrical separation unit 10 draws ions out of the feed stream 12 and produces a second stream 14 that has a lower concentration of ions than the first stream 12. In particular, hardness and TDS are reduced. The second stream 14 flows to the RO unit 20. The RO unit 20 produces a third stream 16 that has lower silica concentration than the second stream 14.

The electrical separation unit 10 may comprise a supercapacitive desalination (SCD) device, an electrodialysis reversal (EDR) device, an electrodialysis device (ED), or a combination thereof. A suitable SCD device is described in U.S. Pat. No. 7,974,076 to Xiong et al., U.S. Patent Publication 2008/0185294 to Cai et al., International Patent Publication WO 2008/094367 to Cai et al., U.S. Patent Publication 2010/0102009 to Silva, U.S. Patent Publication 2010/0242995 to Xiong et al., U.S. Patent Publication 2011/0024354 to Xia et al., U.S. Patent Publication 2011/0042232 to Cai et al., U.S. Patent Publication 2011/0210069 to Xiong et al. and U.S. 2011/0042232 to Cai et al., the disclosures of which are hereby incorporated by reference. A suitable EDR device is described in U.S. Patent Publication 2011/0210069 to Xiong et al. and U.S. Patent Publication 2011/0024354 to Xia et al., the disclosures of which are incorporated herein by reference. A suitable ED device is described in U.S. Pat. No. 8,038,867 to Du et al. and U.S. Patent Publication 2010/024995 to Xiong et al., the disclosures of which are incorporated herein by reference. Suitable commercial SCD, EDR and ED devices are available from GE Water and Process Technologies.

Optionally, the separation unit 10 is an SCD device that receives both the first stream 12 and the fourth stream 18. The SCD device may comprise one or more supercapacitor desalination cells. Each supercapacitor desalination cell may comprise a pair of electrodes, a spacer, and a pair of current collectors attached to respective electrodes. Multiple supercapacitor desalination cells may be stacked together with a plurality of insulating separators positioned between each pair of adjacent supercapacitor desalination cells. The current collectors may be connected to positive and negative terminals of a power source, which allows the electrodes to act as anodes and cathodes.

During a charging state of the SCD device, the first stream 12 enters into the SCD device. In this state, the flow path of the fourth stream 18 to the SCD device may be closed by a valve. Positive and negative electrical charges from the power source accumulate on surfaces of the anode(s) and the cathode(s), respectively and attract anions and cations from the first stream 12. This causes the ions to separate and adsorb on to the surfaces of the anode(s) and the cathode(s), respectively. As a result of the charge accumulation on the anode(s) and the cathode(s), the second stream 14 from the SCD device has a lower TDS content compared to the first stream 12. Hardness is also lower in the second stream 14 compared to the first stream 12.

The SCD device also enters into a discharging state when the adsorbed anions and cations dissociate from the surfaces of the anode(s) and the cathode(s). The fourth stream 18 is pumped to enter the SCD device to wash and carry the anions and cations away from the SCD device in a fifth stream 19. The fifth steam 19 flows from the SCD device and has a higher TDS content as compared with the fourth stream 18. In this discharging state, the flow path of the first stream 12 to the separation unit 10 is closed by a valve. As will be discussed further below, the fourth stream 18 may come from a precipitation unit 30 and the fifth stream 19 may return to the precipitation unit 30. After discharging, the SCD device returns to the charging state such that the SCD device alternates between charging and discharging states and between treating the first stream 12 and the fourth stream 18.

Alternatively, the electrical separation unit 10 may be an ED or EDR device. The EDR device comprises a pair of electrodes configured to act as an anode and a cathode. A plurality of alternating anion-permeable and cation-permeable membranes are disposed between the anode and the cathode to form a series of alternating dilute and concentrate channels between them. The anion-permeable membranes allow the passage of anions through the membrane. The cation-permeable membranes allow the passage of cations through the membrane. Additionally, the EDR device may further comprise a plurality of spacers disposed between each pair of the membranes, and between the electrodes and the adjacent membranes.

While applying electrical current to the EDR device, the first stream 12 passes through the dilute channels and a fourth stream 18 passes through the concentrate channels. The fourth stream 18 may be a solution of dissolved solids, including various salts and ions. In the dilute channels, the first stream 12 is ionized. Cations migrate through the cation-permeable membranes towards the cathode to enter into the adjacent concentrate channels. Anions migrate through the anion-permeable membranes towards the anode to enter into adjacent concentrate channels. While the electrical field exerts a force on the ions toward the respective electrode (e.g. anions are pulled toward the anode) the anions and cations cannot re-enter the dilute channels.

The concentration of ions in the fourth stream 18 increases as it passes through the concentrate channels and carries the anions and cations out of the EDR device. Similar to the SCD device, as the fourth stream 18 passes through the EDR, its ionic content increases and the fourth stream 18 transitions into the fifth stream 19. The fifth stream 19 has a higher ionic content than the fourth stream 18.

The polarity of the electric current applied to the EDR device is switched periodically, for example about every 15 to 50 minutes, to reduce the fouling and scaling tendencies of the anions and cations in the concentrate channels. Thus, in a second polarity state, the dilute channels from a first polarity state may act as the concentrate channels for the fourth stream 18, and the concentrate channels from the first polarity state function as the dilution channels for the first stream 12. An ED device is similar to an EDR device but the ED device does not reverse polarity states.

The fourth stream 18 may be made up of water diverted from one or more of the first stream 12, the second stream 14, the third stream 16 or another available water source. Optionally, the fifth stream 19 may be recycled to the fourth stream 18 but for an amount of the fifth stream 19 that is removed in a blowdown line (not shown). In this case, make up water may also be added to the fourth stream to replace the blowdown. The make up water may be made up of water diverted from one or more of the first stream 12, the second stream 14, the third stream 16 or another available water source.

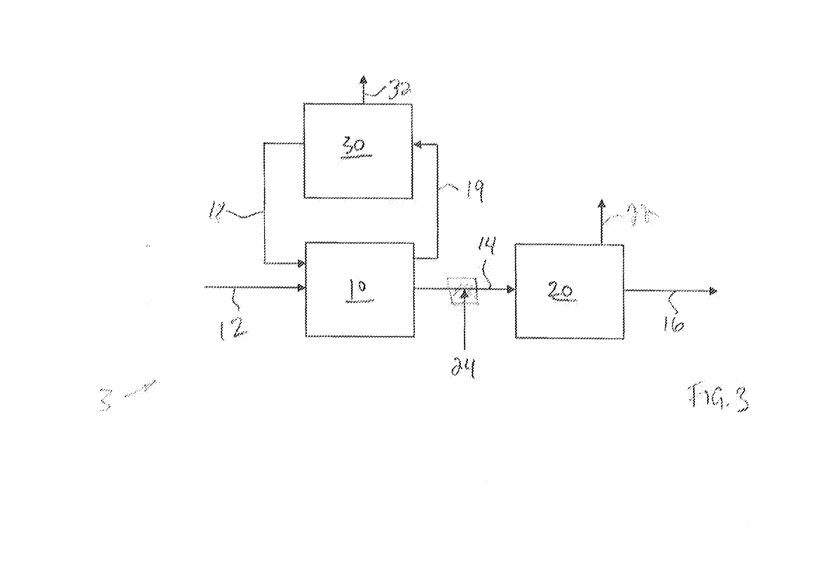

FIG. 2 shows a second system 2. The second system 2 uses components previously described in relation to the system 1 of FIG. 1 as indicated by the use of the same reference numerals in FIG. 2. The second system 2 also has a precipitation unit 30 in fluid communication with the electrical separation unit 10. The precipitation unit 30 may be made of any suitable material, in any shape or configuration that allows precipitates to be removed from the fifth stream 19. Suitable precipitation units are described in U.S. Patent Publications 2011/0024354 and 2011/0114567, both to Xia et al., the disclosures of which are incorporated herein by reference. A suitable combination of an electrical separation unit 10 and a precipitation unit 30 is commercially available from GE Water and Process Technologies. This combination is called a non-thermal brine concentrator (NTBC) and is sold under the AquaSel trade mark.

Optionally, seed particles may be added to the precipitation unit 30. Seed particles may help form precipitates, which may not occur until the degree of saturation or supersaturation is very high. For example, calcium sulfate (CaSO₄) often reaches a degree of supersaturation of 500% before precipitation occurs, which may be disadvantageous to operating the precipitation unit 30. Seed particles may be added into the precipitation unit 30 to induce precipitation on surfaces thereof at a lower degree of supersaturation of the salts or other ions. The seed particles may comprise solid particles including, but not limited to CaSO₄ particles and their hydrates to induce precipitation. The CaSO₄ particles may have an average diameter range from about 10 microns to about 200 microns. In some examples, the CaSO₄ seed particle concentration may be in a range of from about 0.1 wt % to about 2.0 wt % of the weight of the liquid in the precipitation unit 30, so that the concentration of CaSO₄ in the fourth stream 18 leaving the precipitation unit 30 may be controlled in a range of from about 100% to about 150% of saturation. It should be noted that seed particles and additives are not limited to any particular seed particles or additives, and may be selected based on specific applications. Additionally, an agitation device and/or a pump may be provided to facilitate suspension of the seed particles in the precipitation unit 30.

The precipitation unit 30 is part of a recirculation loop that supplies the fourth stream 18 to the electrical separation unit 10 and receives the fifth stream 19 from the electrical separation unit 10. The fourth stream 18 contains various salts and other ions. As the fourth stream 18 flows through the electrical separation unit 10, the concentration of the ionic species may become saturated, or supersaturated. As the fourth stream 18 transitions into the fifth stream 19, precipitates may form. The precipitates are flushed out of the electrical separation unit 10 by the fifth stream 19. The precipitates are then removed from the fifth stream 19, for example by settling in and being withdrawn from the precipitation unit 30. Additionally, precipitates may form and be withdrawn from the precipitation unit 30. The fourth stream 18 exits the precipitation unit 30 and enters the electrical separation unit 10 with a lower concentration of salts and ions than the fifth stream 19.

If the rate of precipitation in the fifth stream 19 equals the rate of ion separation within the first stream 12, the degree of saturation or supersaturation in the fifth stream 19 reaches an equilibrium. In this case, the volume of the fourth and fifth streams 18, 19 may remain relatively constant and decrease the liquid discharge of the electrical separation unit 10 and the precipitation unit 30 to zero or nearly zero.

The precipitation unit 30 may further include a separator to separate precipitates from the fifth stream 19. For example, the separator may be a centrifuge, a filtration unit, a bleed-off valve unit, a skimmer, a flotation unit or an evaporation unit. The precipitation unit 30 may also include an outlet 32 to allow removal of precipitates from the precipitation unit 30.

The second stream 14 flows to the RO unit 20. The RO unit 20 produces the third stream 16, which may have lower amounts of silica than the second stream 14. The third stream 16 is a permeate stream from the RO unit 20. The RO unit 20 may also produce a sixth stream 22 which is the reject stream of the reverse osmosis process.

FIG. 3 shows a third system 3. The third system 3 uses components previously described in relation to the second system 2 of FIG. 2 as indicated by the use of the same reference numerals in FIG. 3. The third system 3 also has a conditioning unit 24 in communication with the RO unit 20. Optionally, the conditioning unit 24 may be added to the water treatment system 1 of FIG. 1 in an analogous manner. The conditioning unit 24 may pretreat or condition the second stream 14 or otherwise enhance the ability of the RO unit 20 to treat the second stream, for example by treating water flowing in a recycle loop associated with the RO unit 20. The conditioning unit 24 may include, for example, one or more of: a device for adding an additive such as an anti-scalant or an acid or a base; an ion exchange unit; a decarbonation unit; a degasifying unit; or, a softener. Although FIG. 3 depicts the conditioning unit 24 between the electrical separation unit 12 and RO unit 20, the conditioning unit 24 may optionally be added upstream and/or downstream of the electrical separation unit 10.

In one option, the conditioning unit 24 may mix an anti-scalant additive into the second stream 14 upstream of the RO unit 20. The anti-scalant additive inhibits the tendency of silica to form scale within the RO unit 20.

In another option, the conditioning unit 24 may be an ion exchange unit such as a weak acid cation exchange unit, a strong acid cation exchange unit or a sodium zeolite cation exchange unit. The ion exchange process further reduces the amount of hardness contributing ions, such as Ca²⁺ and Mg²⁺. The ion exchange process may also reduce the bicarbonate alkalinity content to zero or near zero levels. Bicarbonate alkalinity may also be referred to as non-hydroxide alkalinity. In this option, the pretreatment 24 is preferably downstream of the electrical separation unit 10 and a large portion, if not all, of the hardness and alkalinity ions are already removed from the first stream 12 by the electrical separation unit 10. The ion exchange process of the conditioning unit 24 may be considered a polishing step rather than a bulk softening step. The presence of the electrical separation unit 10 reduces the amount of regeneration waste that would otherwise be required by an ion exchange unit to produce the same hardness level in the feed water to the RO unit 20 without the electrical separation unit 10.

If a reduction in bicarbonate alkalinity is desirable, with or without also using an ion exchange process, the conditioning unit 24 may include adding a soluble acid, for example H₂SO₄, to the second stream 14. Adding acid converts the bicarbonate alkalinity to carbon dioxide. The carbon dioxide is preferably removed with a decarbonation or degasifying unit, also provided within the conditioning unit 24.

In another option, the conditioning unit 24 may include a decarbonation process that follows an ion exchange process or other softening unit without adding an acid. The decarbonation process may remove carbon dioxide by various methods, including: vacuum degasifiers, gas permeable membranes, forced draft decarbonators or combinations thereof.

In another option, the conditioning unit 24 may include adding a soluble alkali or another base, optionally following one or more of a softening unit, an alkalinity reducing unit and a decorbonation unit. Soluble alkali increases the pH of the second stream 14, which increases the solubility and the ionization of some chemical species. For example, adding soluble alkali increases both the ionization and the solubility of the silica in the second stream 14. There are many soluble alkali compounds that are suitable, provided they do not increase the scaling tendency of the third system 3. Examples of suitable alkali may include sodium hydroxide, sodium carbonate, potassium hydroxide, potassium carbonate and the like. The pH of the second stream 14 may be increased to 10.0, or higher, provided that the pH of the second stream 14 remains within the pH tolerance of RO unit 20. Such a pre-treatment may optionally be conducted in a manner similar to a process described in U.S. Pat. No. 5,925,255 to Mukhopadhyay, the disclosure of which is incorporated herein by reference.

Reducing hardness and bicarbonate alkalinity decrease the scale forming tendency of the second stream 14 in the RO unit 20, particularly its silica scaling tendency. The increased solubility and ionization of the silica may also increase the rejection of silica from the membrane unit 20.

The third stream 16 has a lower silica concentration than the second stream 14. The third stream 16 may be suitable for reuse as frac water for further hydraulic fracturing or another purposes. The third stream 16 may also be suitable for disposal by evaporation, subterranean injection or other methods.

Optionally, the first stream 12 may be treated to decrease the amount of suspended particles, colloidal particles, organisms or organic matter before entering the electrical separation unit 10 in any of the systems 1, 2, 3. The treatment process may be a particle removal process such as cartridge filtration, multi-media filtration, microfiltration, ultrafiltration or any combination thereof. The treatment process may also remove organics from the first stream 12 using a membrane bioreactor, a chemical oxidation unit, or any other system that is capable of removing organics from the first stream 12. Other treatments may include de-oiling and de-gassing.

The systems 1, 2, 3 also include a fluid conveyance system that conveys various fluid streams to and from the different components of the system. The conveyance system may comprise a network of pipes, fluid lines and the like that are able to withstand the pressures and the chemical make up of the various fluid streams without degrading or contributing to scale forming within in the system. The conveyance system may also include various pumps and flow control valves that regulate the flow of the various fluid streams. The pumps and flow control valves may be operated manually or under the automatic control of a controller, such as a computer controller.

The systems 1, 2, 3 implement a process having a step of electrically separating ionic species from the blowback water and a step of further silica removal. The step of further silica removal may be performed by reverse osmosis membrane filtration. A step of precipitating the separated ionic species may also be added. Optionally, the electrically treated blowback water may also be conditioned for the silica removal step.

The systems 1, 2, 3 utilize generally compact devices that do not require sources of thermal energy. Accordingly, the systems 1, 2, 3 are suitable for being provided in a mobile unit, for example on a trailer that may be moved by a truck or in a shipping container that may be placed on a train, trailer or other vehicle. The systems 1, 2, 3 may be moved from one location to another, which is useful for frac water treatment since such treatments are required only temporarily at each of many sites. The systems 1, 2, 3 can be used in remote locations not having a source of waste heat or other thermal energy.

This written description uses examples to help disclose the invention and also to enable a person skilled in the art to practice the invention. The patentable scope of the invention is defined by the claims, and may include other examples that occur to those skilled in the art. Although the systems and methods described herein have been described in the context of treating blowback water, they may also be used to treat other sources of similar water.

1. A system for treating water, comprising:
a) an electrical separation unit having an inlet and an outlet; and,
b) a reverse osmosis unit having an inlet and an outlet, wherein the inlet of the reverse osmosis unit is in communication with the outlet of the electrical separation unit.

2. The system of claim 1, further comprising a precipitation unit in a recirculation loop associated with the electrical separation unit.

3. The system of claim 1 wherein the electrical separation unit comprises one or more of: a supercapacitor desalination device; an electrodialysis unit; and, an electrodialysis reversal unit.

4. The system of claim 3, further comprising a precipitation unit in a recirculation loop associated with the electrical separation unit.

5. The system of claim 3, wherein the electrical separation unit comprises a supercapacitor desalination device.

6. The system of claim 1, further comprising a conditioning unit associated with the reverse osmosis unit.

7. The system of claim 6, wherein the conditioning unit is downstream of the electrical separation unit and upstream of the reverse osmosis unit.

8. The system of claim 6, wherein the conditioning unit comprises one or more of: an ion exchange unit; a softening unit; a decarbonation unit; a degasifying unit; and, an additive dosing unit.

9. The system of claim 8, wherein the conditioning unit comprises a pH increasing additive dosing unit.

10. The system of claim 1 provided as a mobile unit.

11. A process for treating water comprising steps of,
a) electrically separating ionic species from the water; and,
b) after step a), removing silica from the water.

12. The process of claim 11 further comprising a step of precipitating the separated ionic species.

13. The process of claim 11 wherein step b) comprises passing the water through a reverse osmosis membrane filtration.

14. The process of claim 13 further comprising a step of conditioning the water for the silica removal step.

15. The process of claim 14 wherein the conditioning step comprises increasing the pH of the water.

16. The system of claim 1 wherein the water is hydraulic fracturing blowback water.

17. The process of claim 11 wherein the water is hydraulic fracturing blowback water.
